(19) United States
(12) Patent Application Publication
(10) Pub. No.: US 2008/0243527 A1
(43) Pub. Date: Oct. 2, 2008

(54) Custom Media Production and Distribution System and Methods

(75) Inventor: Adrian R. Aylward, Newbury (GB)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Macrovision Corporation

(21) Appl. No.: 11/694,649

(22) Filed: Mar. 30, 2007

(51) Int. Cl. G06Q 30/00

(52) U.S. Cl. 705/1

(57) ABSTRACT

A custom media production system and methods have been disclosed. A method comprises generating custom media based on a customer order and other factors, wherein generating includes choosing media, format, or both based on selection information.

### TECHNICAL FIELD

The present invention relates generally to the production and distribution of customized media, particularly to the production and distribution of video discs custom produced for a consumer and containing selected movie trailers.

### BACKGROUND

Typically, media such as video discs are mass-produced, mass-marketed, and made available for purchase only after production. In this model, discs are not customized for an individual consumer purchasing the media. While a video disc containing a movie may contain numerous other extras, such as movie trailers, deleted scenes, and other media, these extras are not customized for the individual user purchasing the disc. The consumer experience and value of the video disc could be enhanced if those extras could be customized to the interests and desires of the individual consumer.

Video discs, such as DVDs, are typically only produced in large volume. Because of costs involved in production, only DVDs of movies that are likely to sell in large quantities are produced. DVDs are distributed primarily where they are likely to be sold, and some DVDs popular in one country or region may not be sold in another country or region. For consumers, there is a growing problem of finding desired movies in the desired media format. A consumer may seek movies that are not commercially popular or not readily available in stores, such as obscure movies or movies from foreign markets.

These problems are compounded by the proliferation of competing media formats. Video can now be stored on DVD, Blu-Ray Disc, HD-DVD, Universal Media Disc, or other formats. A movie may not be readily available in the format desired by a consumer.

### SUMMARY

A custom media selection and production system and methods have been disclosed. A method comprises providing customized media, wherein the content and format of the custom media are customized for each order.

### BRIEF DESCRIPTION OF THE DRAWINGS

The invention will be better understood from a reading of the following detailed description in conjunction with the drawing figures, in which like reference designators are used to identify like elements and in which:

FIG. 1 is a block diagram of an exemplary customized media production and distribution system architecture, according to one embodiment of the present invention;

FIG. 2 is a flow chart illustrating an exemplary custom media selection and production process, according to one embodiment of the present invention;

FIG. 3 is a flow chart illustrating an exemplary process of a catalogue responding to browse requests from a consumer interface, according to one embodiment of the present invention;

FIG. 4 is a flow chart illustrating an exemplary process of the storage customer attributes, according to one embodiment of the present invention;

FIG. 5 is a flow chart illustrating an exemplary process for a custom media generating a production manifest, according to one embodiment of the present invention;

FIG. 6 is a flow chart illustrating an exemplary content selection process, according to one embodiment of the present invention;

FIG. 7 is a flow chart illustrating an exemplary format selection process, according to one embodiment of the present invention;

FIG. 8 is a flow chart illustrating an exemplary custom media production process, according to one embodiment of the present invention; and

FIG. 9 illustrates an exemplary computer architecture for use with the present system, according to one embodiment of the invention.

### DETAILED DESCRIPTION

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

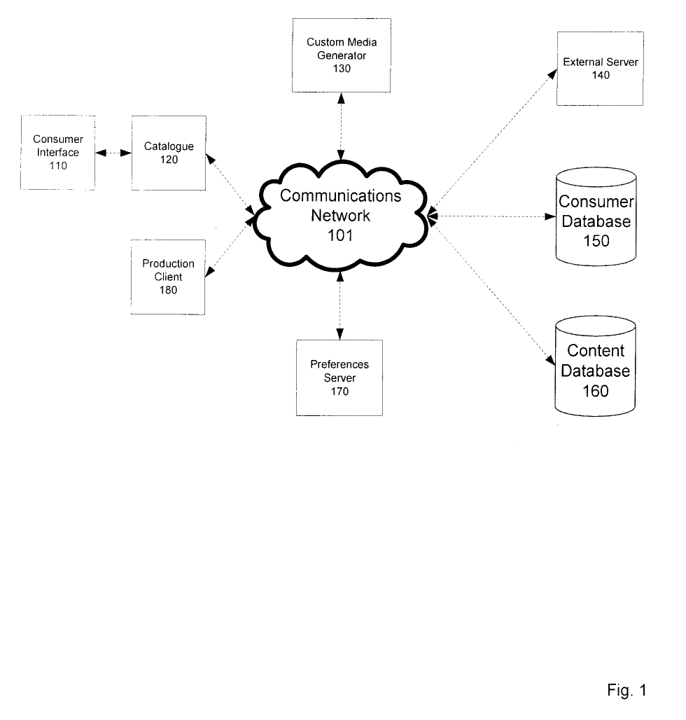

FIG. 1 is a block diagram of an exemplary system architecture, according to one embodiment of the present invention. The consumer interface 110 is a computer system that contains software capable of providing an interface for interaction with users, servers and other network components. A consumer interface includes any electronic system that can provide an interface for interaction with persons, servers and other network components. A consumer interface 110 may be a personal computer, laptop computer, electronic kiosk, video game console (such as Sony Inc.'s Playstation 3), media set-top box (such as TiVO), or mobile device such as a videophone, laptop, smart phone, mobile phone, PDA, game devices such as the PSP manufactured by Sony Electronics, multimedia device such as the iPod manufactured by Apple of Cupertino, Calif., Origami device marketed by Microsoft Corporation of Redmond, Wash., or similar device. The software of consumer interface 110 may be a web browser such as Microsoft Internet Explorer, Apple Safari or Mozilla Firefox, capable of displaying web pages and other information downloaded via the Internet. The software of consumer interface 110 may also be any software capable of displaying information received over the communications link. A consumer interface 110 may also include other supporting computer software and hardware, for example, keyboards, touch-sensitive displays and audio output devices.

In one embodiment, the consumer interface can be associated with an account, using a log-in process. An account includes a collection of attribute data, browsing requests, and other data that may be stored on consumer database 150. Other data that may be associated with an account may include a history of previous custom media orders.

The consumer interface 110 sends and receives information to catalogue 120. For example, the consumer interface 110 may send a custom media purchase request to the catalogue 120.

A custom media purchase request includes information related to a request to generate custom media. In one embodiment, a custom media purchase request is a request for a particular content element, such as a movie. In another embodiment, a custom media purchase request is for multiple content elements, such as a movie and related audio songs. In yet another embodiment, a custom media purchase request does not specify a specific content element. The consumer interface 110 may also send requests for available media and content to the Catalogue 120.

Custom media refers to any media customized for a particular consumer. In one embodiment, custom media is a video disc containing a movie selected through the consumer interface, accompanied by other media elements such as movie trailers selected by custom media generator 130.

The consumer interface 110 communicates with catalogue 120 through any one of a number of protocols and/or applications including HyperText Transport Protocol (HTTP), File Transfer Protocol, (FTP), Secure Socket Layers (SSL).

Catalogue 120 includes any computer system that provides information to a consumer interface 110 and communicates with a custom media generator 130. In an embodiment of the present invention, the information provided to the consumer interface 110 is related to media available as custom media, such as available content elements or format. For example, the catalogue 120 may provide a list of movies available as custom media. In another embodiment, the catalogue 120 receives a custom media purchase request from the customer interface 110 and forwards information related to the custom media purchase request to custom media generator 130. In another embodiment, the information provided by the catalogue 120 to the consumer interface 110 is related to customer attributes, such as address, media preference or billing information. In another embodiment, the catalogue 120 receives information related to customer attributes from the consumer interface 110.

To communicate, catalogue 120 may use communications network 101 or any one of a number of protocols and/or applications including HyperText Transfer Protocol (HTTP), File Transfer Protocol (FTP), Internet Relay Chat (IRC), Secure Socket Layers (SSL), etc., via a TCP/IP connection (not shown in this view) or some other connection well known in the art. The operating system may be Windows®, LINUX, SUN Solaris®, Mac OS or other similar operating system. Catalogue 120 could be built using a combination of technologies such as those from Apache Software (www.apache.org) such as Tomcat servers; Java based technologies such as J2EE, EJB, JBOSS, JDBC; and/or databases such as MySQL. A catalogue 120 may also include other supporting computing software and hardware, for example, databases, computers, and user interface servers.

A communications network 101 includes communications networks, including those based on TCP/IP protocols, Wide Area Networks (WAN), Local Area Networks (LAN), mobile wireless networks, and any other system of interconnection enabling two or more devices to exchange information. In an embodiment of the current invention, catalogue 120, custom media generator 130, external server 140, consumer database 150, content database 160, preferences server 170, and production client 180 may transmit information to one another using communications network 101.

The custom media generator 130 is a computer system that contains software that receives a custom media purchase request from catalogue 120 and generates one or many production manifests. The custom media generator 130 transmits production manifests to a production client 180 for generation of custom media. In another embodiment, the custom media generator 130 may communicate with preferences server 170 and external server 140 to receive information to generate a production manifest.

A production manifest includes information that describe custom media to be produced in response to the custom media purchase request. In an embodiment, a production manifest includes information listing the content elements for the requested custom media. A content element includes data relating to media content of any type (including video, music, text, or image). For example, a content element may be a film, movie trailer, extra movie material, advertisement, musical song, or picture image. In another embodiment, a production manifest includes information listing the format of the custom media. Format includes the type of custom media to be generated. In an embodiment of the present invention, a production manifest may include both content element information and format information. In another embodiment of the present invention, a production manifest may include content elements of different types for one custom media. For example, a custom media may contain video, music, and text.

A format may be HD-DVD, Blu-Ray Disc, DVD, VCD, Universal Media Disc, Windows Media High Definition Disc, LaserDisc, VHS, CD, DVD-Audio, DVD-R or DVD-RAM. In another embodiment of the current invention, a format may refer to a downloadable computer file format, such as Windows Media, Quicktime Video, Apple Audio Compression, MP3, MP4, MPG, or Real Media. In one embodiment, a format may also include widescreen (referring to video displayed using a 16:9 ratio of width to height) or full (referring to video displayed using a 4:3 ratio of width to height).

A custom media generator 130 is built using a combination of technologies such as those from Apache Software (www.apache.org) such as Tomcat servers; Java based technologies such as J2EE, EJB, JBOSS, JDBC; and/or databases such as MySQL. The operating system may be Windows®, LINUX, SUN Solaris®, Mac OS or other similar operating system. A custom media generator 130 may also include other supporting computing software and hardware, for example, databases, computers, and user interface servers.

An external server 140 includes any computer system that provides information to a custom media generator 130. An external server 140 could be built using a combination of technologies such as those from Apache Software (www.apache.org) such as Tomcat servers; Java based technologies such as J2EE, EJB, JBOSS, JDBC; and/or databases such as MySQL. An external server 140 may also include other supporting computing software and hardware, for example, databases, computers, and user interface servers.

Consumer database 150 and content database 160 are computer systems with software that performs information storage, and are not limited to those based on relational database technologies such as SQL. In an embodiment of the current invention, a consumer database 150 stores information related to a user, such as consumer attributes or media browsing history. In another embodiment of the current invention, a content database 160 stores content elements. In yet another embodiment, a content database 160 stores information relating to content elements, such as download location of a content element.

Preferences server 170 includes any computer system that provides information related to a custom media request to a custom media generator 130. The preferences server 170 receives a custom media purchase request. In one embodiment of the current invention, the preferences server 170 requests information from the consumer database 150, the content database 160, or both. In another embodiment of the current invention, the preferences server 170 determines available formats for the requested custom media. In another embodiment of the current invention, the preferences server 170 determines available content elements for the requested custom media A preferences server 170 is built using a combination of technologies such as those from Apache Software (www.apache.org) such as Tomcat servers; Java based technologies such as J2EE, EJB, JBOSS, JDBC; and/or databases such as MySQL.

A production client 180 includes any computer system that includes hardware and software for producing custom media. The production client 180 receives a production manifest from custom media generator 130, produces custom media based on the production manifest, and makes the custom media available. In an embodiment of the present invention, a production client 180 may make custom media available for download over the Internet, by forwarding the custom media to the consumer interface via a mail service such as the United States Postal Service, by forwarding the custom media to a retail outlet for later pick-up, or by making the custom media available at the production client for immediate pick-up. A production client 180 may be built using a combination of technologies such as those from Apache Software (www.apache.org) such as Tomcat servers; Java based technologies such as J2EE, EJB, JBOSS, JDBC; and/or databases such as MySQL. A production client 180 may also include other supporting computer software and hardware, for example, keyboards, touch-sensitive displays output devices, and drives for writing data on DVDs or CDs.

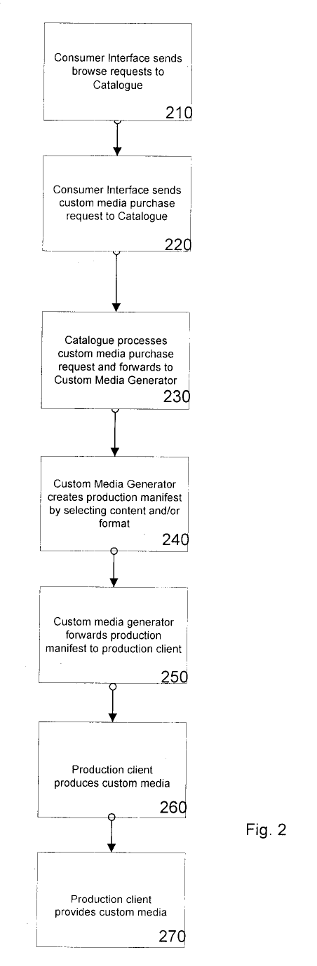

FIG. 2 is a flowchart illustrating an exemplary custom media production process using a custom media generator 130, according to one embodiment of the present invention. A consumer interface 110 transmits browse requests to the catalogue 120 (210). Browse requests may be requests for listings of content elements available to be ordered as custom media. In another embodiment, browse requests are requests for content elements stored in content database 160. In one embodiment, browse requests are stored in consumer database 150.

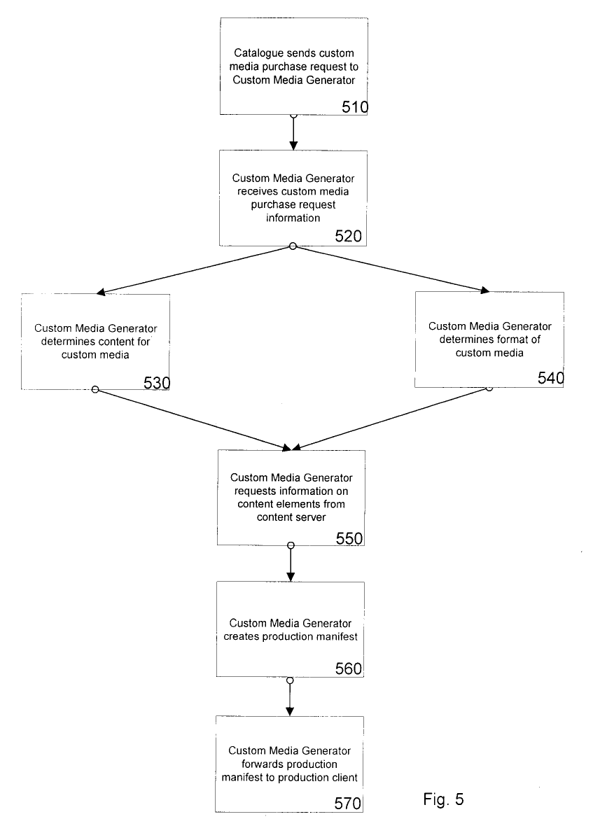

A customer interface 110 sends a custom media purchase request to the catalogue 120 (220). The catalogue 120 receives the custom media purchase request (230). In one embodiment, the catalogue 120 may use details of the custom media purchase request to verify billing information or to charge a bank account, credit card, or user account for the custom media. The catalogue 120 transmits information in the custom media request to the custom media generator 130 (230). The custom media generator 130 creates a production manifest for custom media, as further discussed in FIG. 5 (240). In one embodiment, the custom media generator 130 requests information from preferences server 170 to create the production manifest. The production manifest may include information about content elements for the custom media, the format of the custom media, and other information. The custom media generator 130 forwards the production manifest to the production client 180 (250). The production client 180 produces custom media, according to the production manifest (260). The production client 180 provides the custom media by making the produced custom media available (270).

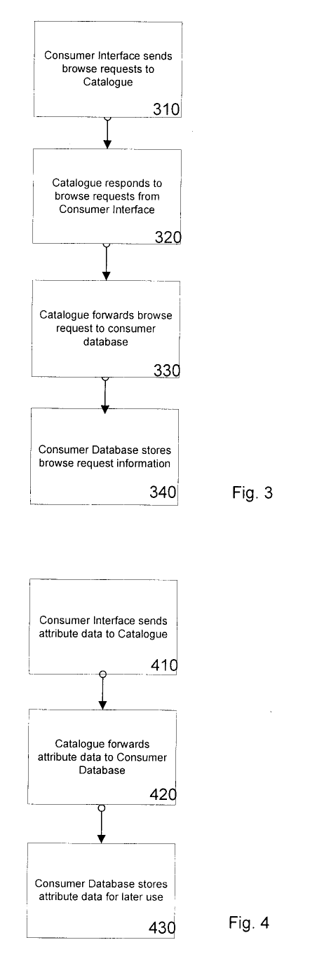

FIG. 3 is a flowchart illustrating an exemplary process for the catalogue 120 and the consumer interface 110 to interact using browse requests. A consumer interface 110 sends a browse request to the catalogue 120 (310). In one embodiment, the consumer interface 110 and the catalogue 120 are software installed on different computers connected via a communications link, and the consumer interface 110 transmits the request to the catalogue 120 using a communications link, such as Ethernet. In a further embodiment, the consumer interface 110 is a web browser software. In another embodiment, the consumer interface 110 and catalogue 120 are software installed on a single computer, and the consumer interface 110 transmits the browse request using shared memory or a computer bus.

A catalogue 120 receives the browse request from the consumer interface 110 (320). The catalogue responds to the browse request from the consumer interface 110 by transmitting information in response to the browse request (330). In one embodiment, the catalogue responds to the browse request by sending to the consumer interface 110 a list of content elements available on content database 160.

In one embodiment, the catalogue 120 stores browse requests from a consumer interface 110 on consumer database 150 (340). In one embodiment, the browse request is associated with an account. In a further embodiment, the consumer database 150 stores browse requests associated with an account.

FIG. 4 is a flowchart illustrating an exemplary process for storage of account attributes, according to one embodiment of the present invention. A consumer interface 110 sends attribute data to catalogue 120 (410). Attribute data may be shipping information for custom media; billing and payment information, preferred format of custom media, preferred method of delivery of custom media, film rating limit (such as “PG-13” or other code used by the Motion Picture Association of America) or other personalized information. In one embodiment, attribute data may be associated with a particular account. Attribute data may include information regarding a preferred type of extra content elements, such as actor profiles or additional deleted scenes.

Catalogue 120 sends the attribute data to the consumer database 150 (420). The consumer database stores the attribute data (430). In one embodiment, the consumer database 150 associates the data with an account. In another embodiment, attribute data is not associated with any account.

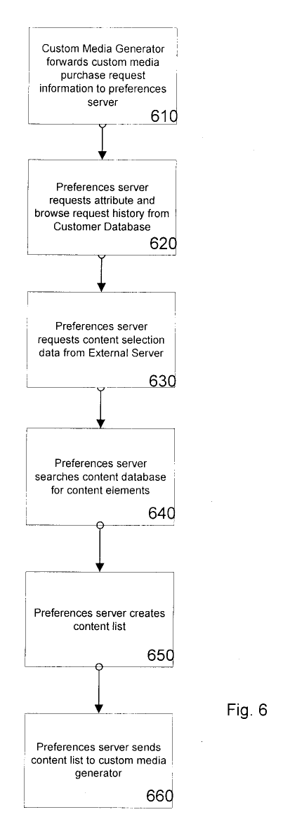

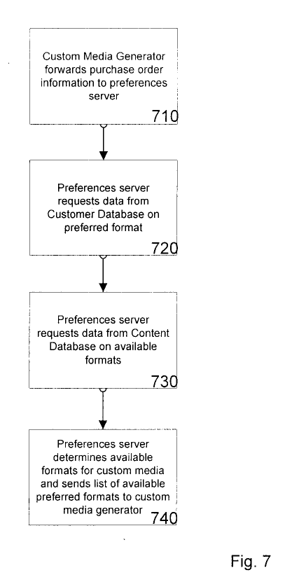

FIG. 5 is a flowchart illustrating an exemplary process for a custom media generator generating a production manifest, according to one embodiment of the present invention. Catalogue 120 sends information from a custom media purchase request to the custom media generator 130 (510). The custom media generator 130 receives the custom media purchase request (520). The custom media generator 130 selects media information for a production manifest. Media information may include content elements, format, and other information describing custom media. In one embodiment, the custom media generator determines the content elements for custom media (530), as further discussed with respect to FIG. 6. In another embodiment, the custom media generator determines a format for the custom media (540), as further discussed with respect to FIG. 7. In yet another embodiment, the custom media generator determines both the content elements for custom media and format for custom media.

The custom media generator 130 transmits to the content database 160 a request for information about the content elements for the custom media (550). In one embodiment, the custom media generator 130 receives from the content database 160 location information about the custom media content elements. This location information allows a production client to access the content elements. In another embodiment, the custom media generator 130 receives the requested content element from the content database 160.

The custom media generator 130 generates a production manifest containing the content elements for the custom media (560). In another embodiment, the production manifest also specifies a format for the custom media. The custom media generator 130 forwards the production manifest to the production client 180 (570).

FIG. 6 is a flowchart illustrating an exemplary content element selection process, according to one embodiment of the present invention. The custom media generator 130 forwards custom media purchase request information to the preferences server 160 (610). In an embodiment, the preferences server requests and receives attribute data, browsing request history or other data from customer database 150 (620). In another embodiment, the preferences server requests and receives attribute data, browse request history or other account data of the account associated with a custom media purchase request.

In another embodiment, the preferences server requests and receives content selection data from external server 140 (630). In yet another embodiment, the preferences server requests and receives content selection data from more than one external server 140. In one embodiment, content selection data includes data from third parties to associate certain content elements with custom media purchase requests. In one embodiment, content selection data may associate a particular movie trailer with custom media purchase requests for movies. For example, content selection data may associate certain audio content elements with custom media purchase requests for a particular movie. Content selection data may be instructions to include songs from a movie soundtrack on any custom media containing that movie.

The preferences server 170 searches content database 160 for content elements to include on custom media (640). In one embodiment, the preferences server 170 searches for content elements indicated by attribute data, browsing request history or other data received from customer database 150. For example, preferences server 170 may search for movie trailers corresponding to movies in previous browse requests associated with the account making the custom media purchase request. In another example, attribute data may direct a preferences server 170 to search for deleted scenes content elements for a movie custom media. In another embodiment, the preferences server 170 searches for content elements indicated in the content selection data from external server 140. For example a preferences server 170 may search for movie trailers from the same movie studio as the movie found in the custom media purchase request. In another embodiment, the preferences server 170 searches for content elements similar to content elements to the content element requested in the custom media purchase request. For example, if a custom media purchase request indicates a particular movie, a preferences server 170 may search for content elements featuring actors found in the requested movie.

The preferences server creates a list of content elements for the requested custom media (650). The preferences server sends the list of content elements for the requested custom media to the custom media generator (660). In yet another embodiment, the preferences server stores information related to the content elements chosen for of the custom media on consumer database 150. Information related to the content elements of the custom media may be associated with the account ordering the custom media.

FIG. 7 is a flowchart illustrating an exemplary format selection process, according to one embodiment of the present invention. The custom media generator 130 forwards custom media purchase request information to the preferences server 160 (710). The preferences server requests and receives attribute data, browse request history or other data from customer database 150 (720). In an embodiment, the preferences server requests and receives attribute data, browse request history or other account data of the account associated with a custom media purchase request. In an embodiment, the attribute data indicates preferred formats for custom media. For example, an account attribute may indicate that the preferred custom media format is Blu-Ray Disc. In another example, an account attribute may specify the preferred region encoding for a DVD. In another example, an account attribute may specify the preferred aspect ratio for video is widescreen (16:9) or full screen (4:3). In yet another embodiment, the preferences server determines preferred formats from the previous custom media purchases associated with the account.

The preferences server 170 requests and receives available formats for custom media from the content database 160 (730).

The preferences server 170 determines the available preferred formats for custom media and sends a list of available preferred formats to the custom media generator 130 (740). In an embodiment, the preferences server 170 determines the available preferred formats by determining which preferred formats are available from content database 160.

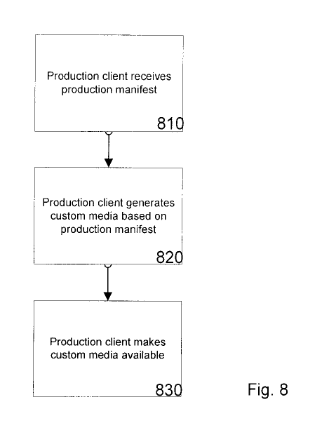

FIG. 8 is a flowchart illustrating an exemplary custom media production process, according to one embodiment of the present invention. The production client 180 receives a production manifest for custom media (810). The production client 180 generates custom media based on the production manifest for custom media (820). The production client 180 generates the custom media including the content elements specified in the production manifest. In another embodiment, the production client 180 generates the custom media on the format specified in the production manifest. For example, a production client 180 may create a custom DVD containing content elements in the HD-DVD format specified by the production manifest.

The production client 180 makes custom media available (830). In one embodiment, the production client 180 is a stand-alone kiosk that creates a DVD or other physical media for pickup by the designated consumer. In another embodiment, the production client 180 is located on the same computer system as consumer interface 110. In another embodiment, the production client 180 is a computer system that creates a DVD or other physical media and sends the DVD or other media via the United States Postal Service, Federal Express, or other mail delivery. In yet another embodiment, a production client 180 may create downloadable computer files and transmit them over the Internet or any other communications link.

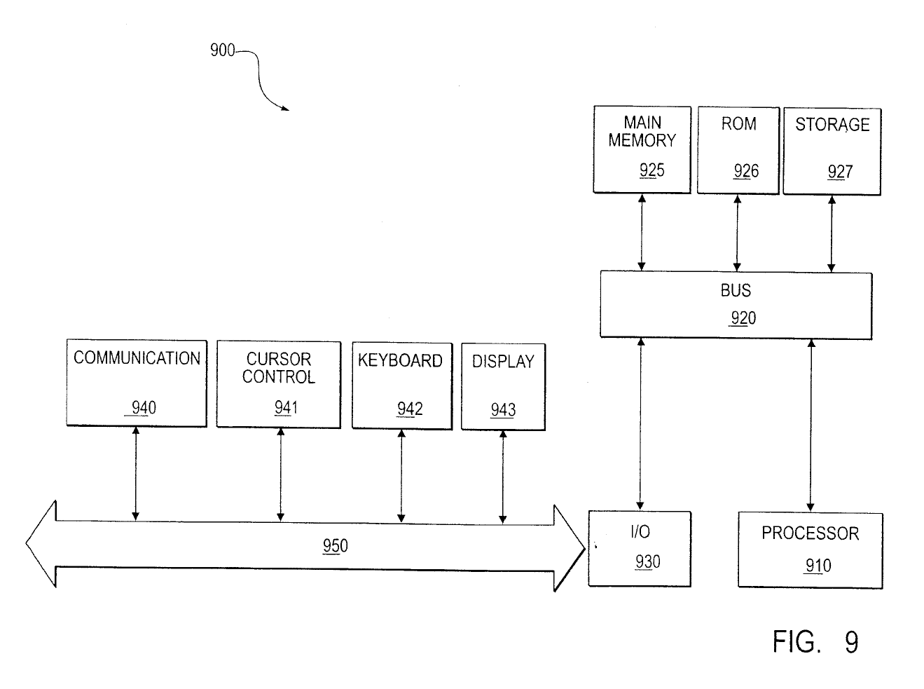

FIG. 9 illustrates an exemplary computer architecture for use with the present system, according to one embodiment of the invention. Computer architecture 900 implements a consumer interface 110, a catalogue 120, a custom media generator 130, an external server 140, a consumer database 150, a content database 160, a preferences server 170, and a production client 18 of FIG. 1. One embodiment of architecture 900 comprises a system bus 920 for communicating information, and a processor 910 coupled to bus 920 for processing information. Architecture 900 further comprises a random access memory (RAM) or other dynamic storage device 925 (referred to herein as main memory), coupled to bus 920 for storing information and instructions to be executed by processor 910. Main memory 925 also may be used for storing temporary variables or other intermediate information during execution of instructions by processor 910. Architecture 900 also may include a read only memory (ROM) and/or other static storage device 926 coupled to bus 920 for storing static information and instructions used by processor 910.

A data storage device 927 such as a magnetic disk or optical disc and its corresponding drive may also be coupled to computer system 1900 for storing information and instructions. Architecture 900 can also be coupled to a second I/O bus 950 via an I/O interface 930. A plurality of I/O devices may be coupled to I/O bus 950, including a display device 943, an input device (e.g., an alphanumeric input device 942 and/or a cursor control device 941). For example, a consumer interface 110 may be presented to the user on the display device 943.

The communication device 940 allows for access to other computers (servers or clients) via a network. The communication device 940 may comprise a modem, a network interface card, a wireless network interface or other well known interface device, such as those used for coupling to Ethernet, token ring, or other types of networks.

A custom media production system and methods have been disclosed. Although the present methods and systems have been described with respect to specific examples and subsystems, it will be apparent to those of ordinary skill in the art that it is not limited to these specific examples or subsystems but extends to other embodiments as well.

What is claimed is:

1. A method, comprising:
receiving from a client, a request to generate custom media for a specific user;
selecting automatically media information associated with the specific user to generate the custom media; and
generating a production manifest that provides instructions to generate the custom media, the custom media including first content specifically requested by the specific user, and second content associated with the media information.

2. The method of claim 1, the second content including targeted advertising.

3. The method of claim 2, wherein the first content is chosen based on user specific information including media format.

4. The method of claim 2, wherein the first content and second content are selected based on consumer attribute information.

5. The method of claim 2, wherein the first content and second content are selected based on previous requests for custom media.

6. The method of claim 2, wherein the second content are selected based on marketing information.

7. The method of claim 2, wherein the content elements are selected based on the format of the custom media.

8. The method of claim 1, wherein the selection automatically of media information includes selecting a format for the custom media.

9. The method of claim 8, wherein a format for custom media is selected based on consumer attribute information.

10. The method of claim 8, wherein a format for custom media is selected based on a format specified in the request for custom media.

11. The method of claim 8, wherein a format for custom media indicates the medium for the produced custom media.

12. The method of claim 8, wherein a format for custom media indicates the media type of the content elements for the produced custom media.

13. The method of claim 1, further comprising producing custom media on a format of the production manifest and delivering custom media in response to the request for custom media.

14. The method of claim 13, wherein the custom media is delivered at a kiosk.

15. The method of claim 13, wherein the custom media is delivered via a computer network.

16. The method of claim 13, wherein the custom media is delivered via a postal mail service.

17. The method of claim 1, further comprising:
receiving requests for available custom media;
responding to those requests with information concerning custom media; and
storing the requests for available custom media.

18. The method of claim 1, wherein the production manifest includes information about the location of content elements for the custom media.

19. The method of claim 1, wherein the production manifest includes content elements for the custom media.
